(19) United States
(12) Patent Application Publication
(10) Pub. No.: US 2003/0039264 A1
(43) Pub. Date: Feb. 27, 2003

(54) Device and method for displaying code domain power

(76) Inventor: Takayuki Hando, Hyogo (JP)

Correspondence Address: Paul D Greeley, Ohlandt Greeley Ruggiero & Perle, One Landmark Square 10th Floor, Stamford, CT, 06901-2682, US

(21) Appl. No.: 10/149,713

(22) PCT Filed: Dec. 27, 2000
(86) PCT No.: PCT/JP00/09295

(30) Foreign Application Priority Data
Dec. 29, 1999 (JP) 11/377454

(51) Int. Cl. H04B 7/216

(52) U.S. Cl. 370/441

(57) ABSTRACT

In an HPSK modulating process of carrying different items of information on I- and Q-axes on an HPSK signal dot diagram, it is necessary to take into account another different dimension in addition to codes on the code domain. The present invention provides an improved method of displaying code domain power (CDP). After an IF signal produced by converting a frequency of a CDMA signal is IQ-demodulated, I and Q component signals are individually descrambled and despread as BPSK modulated signals. After CDPs are calculated from descrambled and despread signals, they are displayed as a CDP of an I-axis and a CDP of a Q-axis. By displaying the components on different axes as shown in FIG. 4, the power distributed on the I- and Q-axes and the relationship between the power and codes can quickly be recognized visually.

### TECHNICAL FIELD

The present invention relates to an apparatus for testing a mobile communication system. More particularly, the present invention relates to an apparatus and a method for displaying code domain power in a code domain measuring apparatus.

### BACKGROUND ART

For measuring the code domain power (CDP) of a CDMA (Code Division Multiple Access) signal such as of cdmaOne(TM) or the like with a conventional code domain measuring apparatus, it has been customary for the code domain measuring apparatus to employ a process of displaying codes on a horizontal axis and the power of the codes on a vertical axis, as shown in FIG. 1 of the accompanying drawings.

The applicant (assignee) of the present application has filed Japanese patent application No. 11-125658 entitled “Method of displaying the power level of CDMA signal” on May 6, 1999. In the disclosed method, there has been described a process of displaying the power levels in respective active code channels in a plurality of code layers with bars shown in FIG. 1. The Japanese patent application discloses a technique for indicating in which code layer each active code channel is active and allowing the observer to observe the power level easily, using the width of the bars shown in FIG. 1.

One apparatus for carrying out such a process of code domain power is shown in FIGS. 2 and 3 of the accompanying drawings. FIG. 2 is a block diagram of a conventional code domain power analyzing apparatus 20, and FIG. 3 is a detailed block diagram of a digital processor 24 which is part of the code domain power analyzing apparatus 20. An intermediate frequency (IF) signal is generated from an input CDMA signal (RF signal) by a down converter 21 and a low-pass filter 22. The IF signal is input to an analog-to-digital converter (A/D converter) 23, which inputs a digital IF signal to a digital processor 24. As shown in FIG. 3, the digital processor 24 comprises an IQ demodulator 31, filters 32, a descrambler/despreading means 33, and a code domain power (CDP) calculator 34. The digital IF signal is divided by the IQ demodulator 31 into an in-phase (I) component signal and a quadrature (Q) component signal, which are supplied through the respective filters 32 as QPSK modulated signals containing amplitude and phase information to the descrambling/despreading means 33, respectively. The descrambler/despreading means 33 descrambles and despreads the two component signals as the QPSK modulated signals. The CDP calculator 34 calculates CDP from an output signal from the descrambling/despreading means 33, and generates a signal for displaying the bars as shown in FIG. 1 on a display unit 25.

The Japanese patent application also discloses a process of displaying the bars in different colors to distinguish the power of an active code channel from the power of inactive code channels. The disclosed process makes it possible to allow the observer to observe the power of a plurality of code layers at the same time, unlike the conventional process which has allowed the observer to observe the code power of only one code layer per screen on the measuring unit.

There has in recent years been proposed a modulating process referred to as HPSK (Hybrid Phase Shift Keying) (also known as OCQPSK (Orthogonal Complex Quadrature Phase Shift Keying) as a spreading process for use in W-CDMA and cdma2000 which are new standards to be introduced in the future, for the purpose of increasing the frequency utilization efficiency of upstream signals from terminal devices to base stations. The proposed modulating process is a process of carrying different items of information on I- and Q-axes of the constellation (signal dot diagram). For measuring an upstream CDMA signal according to the modulating process, it is necessary to take into account another different dimension in addition to codes on the code domain. The power of codes and leakages of the power to other codes, not only in one axis, but also from the I-axis to the Q-axis and vice versa, need to be measured and displayed so that they can be read accurately and quickly. However, it is impossible for the conventional CDP displaying process shown in FIG. 1 and the conventional apparatus shown in FIGS. 2 and 3 to display the power of the I-axis and the power of the Q-axis distinguishably from each other.

### DISCLOSURE OF THE INVENTION

It is an object of the present invention to provide a novel method of displaying code domain power and a novel apparatus for measuring code domain power, which are suitable for analyzing a CDMA signal according to an HPSK modulating process.

To achieve the above object, an apparatus for displaying code domain power according to the present invention is arranged as follows: The apparatus has a down-converter for receiving a CDMA signal and down-converting the CDMA signal into an intermediate frequency (IF) signal, a analog-to-digital (A/D) converter for converting the generated IF signal into a digital IF signal, a digital signal processor for demodulating the digital IF signal into I and Q components, descrambling and despreading the I and Q components to calculate code domain power (CDP), and display for displaying the CDP in response to signals from the digital signal processor, wherein the digital signal processor descrambles and despreads I and Q component signals having amplitude and phase information obtained by demodulating the digital IF signal, individually as BPSK modulated signals, calculates CDPS with respect to I- and Q-axes from two different signals calculated by descrambling and despreading the I and Q component signals, and has the display show the CDPs of each of the I- and Q-axes distinguishably. Since the I and Q components are individually descrambled and despread, the power distributed on the I- and Q-axes by HPSK can distinguishably be extracted and displayed to the advantage of the observer.

The digital signal processor may descramble and despread I and Q component signals having amplitude and phase information obtained by demodulating the digital IF signal, as QPSK modulated signals with a first scrambling code, and simultaneously descramble and despread the I and Q component signals as QPSK modulated signals with a second scrambling code, calculate CDPs with respect to I- and Q-axes from two different signals obtained by descrambling and despreading the I and Q component signals with the scrambling codes, and display the CDPs corresponding to the first and second scrambling codes distinguishably on the display. With this arrangement, the code domain powers with respect a downstream signal scrambled with different scrambling codes can be simultaneously displayed for the respective scrambling codes. Since the scrambling codes are assigned to respective cells or sectors, the code domain power between sectors or cells can simply be observed advantageously.

In addition, the digital signal processor may be arranged to enable the display to display the CDPs calculated from the two different signals calculated by descrambling and despreading the I and Q components, on respective different axes of dimension. With this arrangement, the power distributed on the I- and Q-axes and the relationship between the power and codes can quickly be recognized visually. The arrangement is also highly advantageous in that it can not only determine whether an upstream signal modulator is normal or not, but also can easily obtain information necessary to analyze the cause of a malfunction. For displaying the CDP of a downstream signal scrambled with different scrambling codes, since the powers are displayed on different axes of dimension for respective codes, the powers can be simultaneously displayed and the power distribution can quickly be recognized visually.

Alternatively, the digital signal processor may be arranged to enable the display to display the CDPs calculated from the two different signals calculated by descrambling and despreading the I and Q components, on an identical axis of dimension in a stacked fashion. With this arrangement, the total power for the same code that is distributed on the I-axis and the Q-axis can easily be observed. This function is particularly effective in confirming the power distribution for the codes as required in an initial phase of development of terminals.

Further alternatively, the digital signal processor may be arranged to enable the display to display the CDPs in a visually distinguishable manner with colors or patterns, said CDPs have been calculated from the two different signals calculated by descrambling and despreading the I and Q components. With this arrangement, the power at a desired code and the power distributed on the I- and Q-axes can be distinguished from each other.

### BRIEF DESCRIPTION OF THE DRAWINGS

FIG. 1 is a diagram showing a conventional manner for displaying CDP;

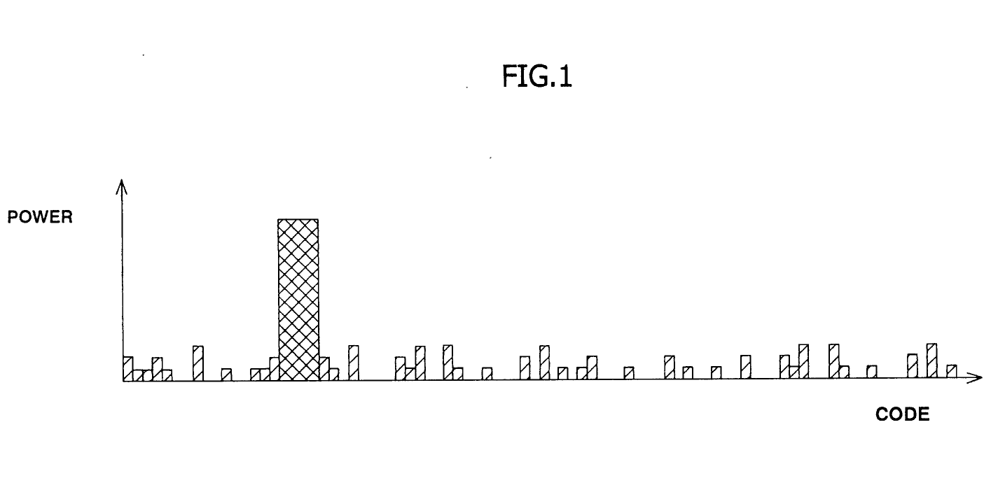

FIG. 2 is a block diagram of a conventional code domain power analyzing apparatus 20;

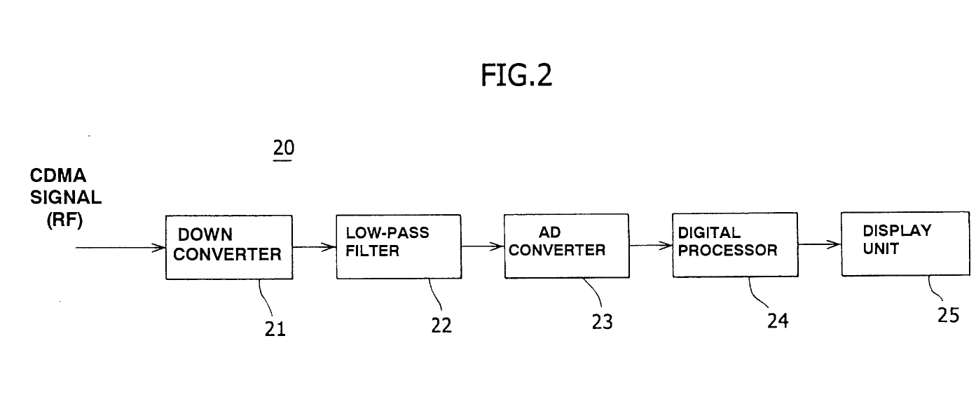

FIG. 3 is a detailed block diagram of a digital processor 24 shown in FIG. 2;

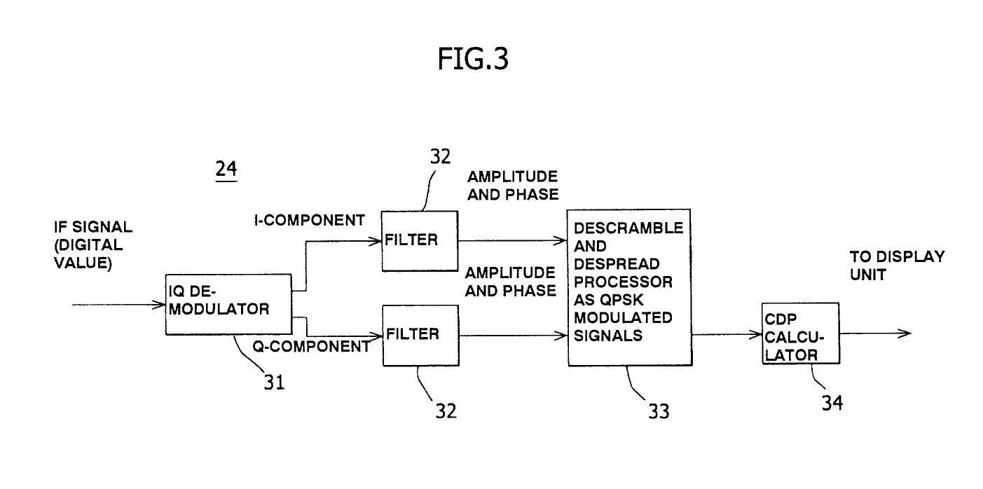

FIG. 4 is a diagram showing a style for displaying CDP according to an embodiment of the present invention;

FIG. 5 is a block diagram of a code domain power analyzing apparatus 50 according to the present invention;

FIG. 6 is a detailed block diagram of a digital processor 54 shown in FIG. 5;

FIG. 7 is a block diagram of a code domain power analyzing apparatus 70 according to a second embodiment of the present invention;

FIG. 8 is a detailed block diagram of a digital processor 74 shown in FIG. 7; and

FIG. 9 is a diagram showing a style for displaying CDP according to another embodiment of the present invention.

### BEST MODE FOR CARRYING OUT THE INVENTION

Embodiments which are considered as best at present will be described in detail below with reference to the drawings. Components denoted by like reference numerals have like functions throughout the figures.

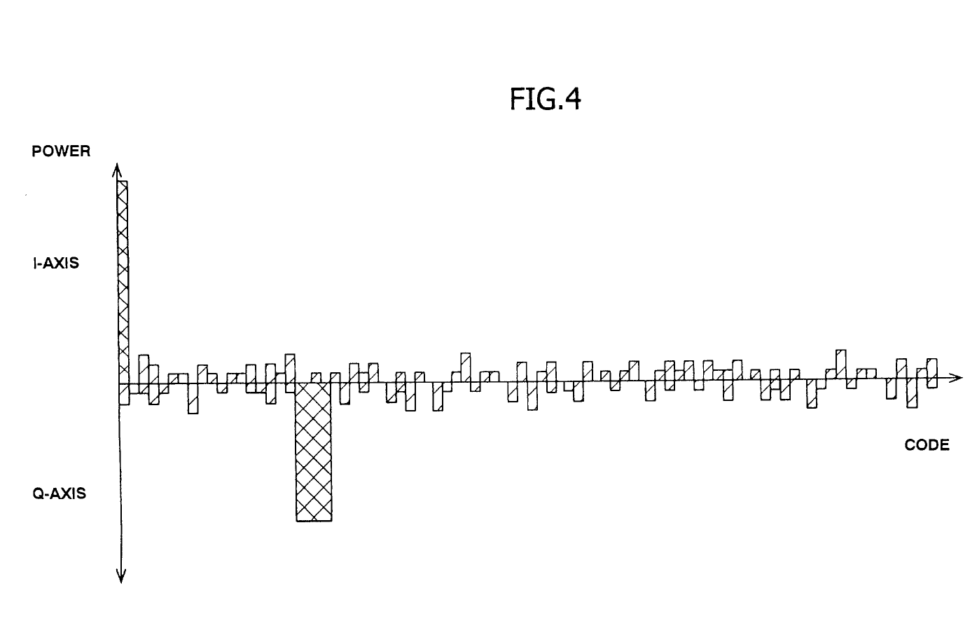

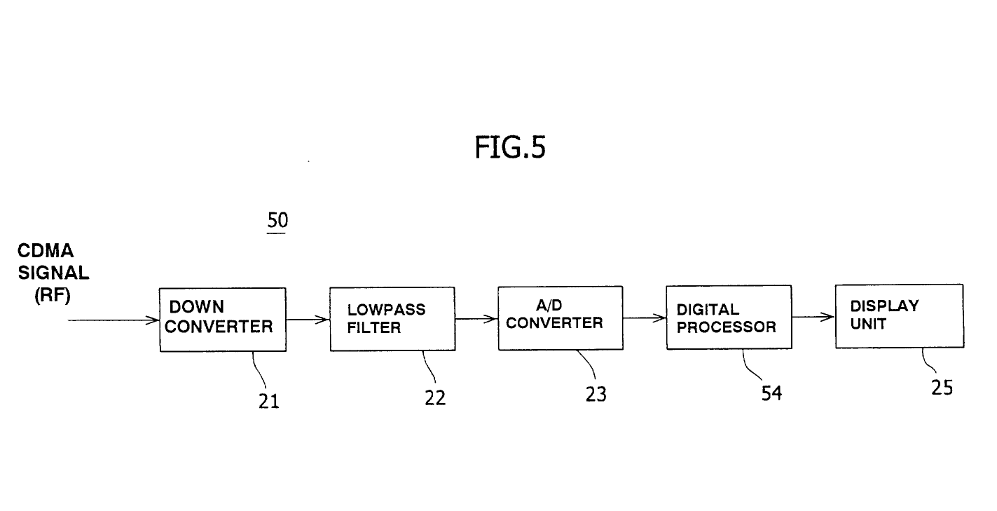

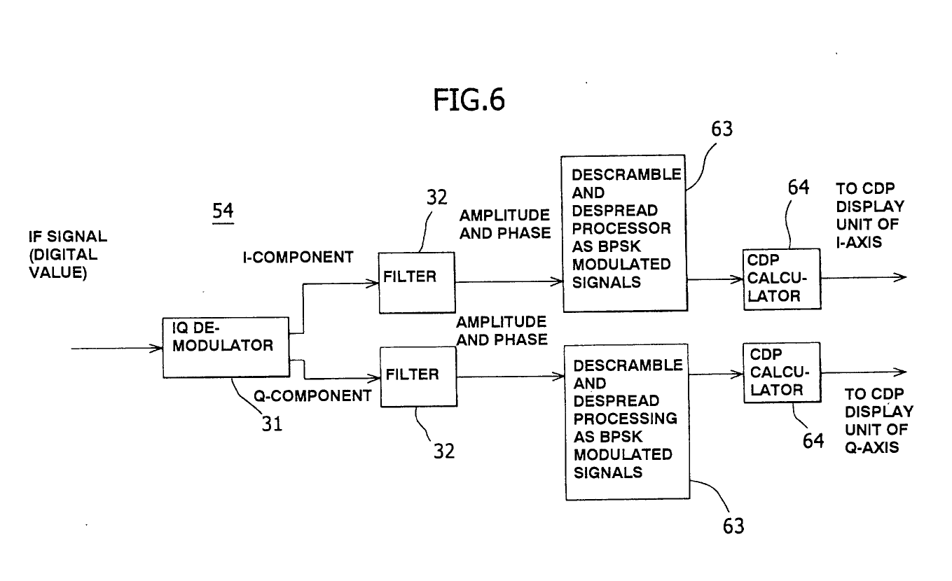

As shown in FIG. 4, a method of displaying code domain power (hereinafter referred to as CDP) according to the present invention for achieving the above object simultaneously displays the power of the I-axis and the power of the Q-axis as bars above and below a horizontal axis (codes) (e.g., the power of the I-axis above the horizontal axis and the power of the Q-axis below the horizontal axis), with each of the bars having a length representing the power level and a width representing a code layer where an active channel locates. FIG. 5 is a block diagram of a code domain power analyzing apparatus 50 according to the present invention for carrying out the above method, and FIG. 6 is a detailed block diagram of a digital processor 54 which is part of the code domain power analyzing apparatus 50. Basically, the block diagram of the CDP analyzing apparatus 50 is the same as the block diagram of the conventional CDP analyzing apparatus 20, but differs essentially therefrom in that the digital processor 54 descrambles and despreads an I component and a Q component as BPSK modulated signals separately from each other as shown in FIG. 6. A sequence of operation of the CDP analyzing apparatus 50 according to the present invention will be described below.

A received CDMA signal (RF signal) is down-converted into an intermediate frequency (IF) signal by a down converter 21 and a low-pass filter 22. The IF signal is input to an analog-to-digital converter (A/D converter) 23, which inputs a digital IF signal to the digital processor 54. As shown in FIG. 6, the digital processor 54 comprises an IQ demodulator 31, filters 32, descrambler/despreading means 63, and code domain power (CDP) calculators 64. By means of the IQ demodulator 31, the digital IF signal is divided into an in-phase (I) component signal and a quadrature (Q) component signal, which are supplied through the respective filters 32 as BPSK modulated signals containing amplitude and phase information individually to the respective descrambler/despreading means 63. The descrambler/despreading means 63 individually descramble and despread the two component signals respectively as the BPSK modulated signals. A signal obtained from the I component signal is input to one of the CDP calculator 34, which calculates CDP of the I-axis. A signal obtained from the Q component signal is input to the other CDP calculator 34, which calculates CDP of the Q-axis. These CDP calculator 34 generate signals for displaying the bars as shown in FIG. 4 on a display unit 25.

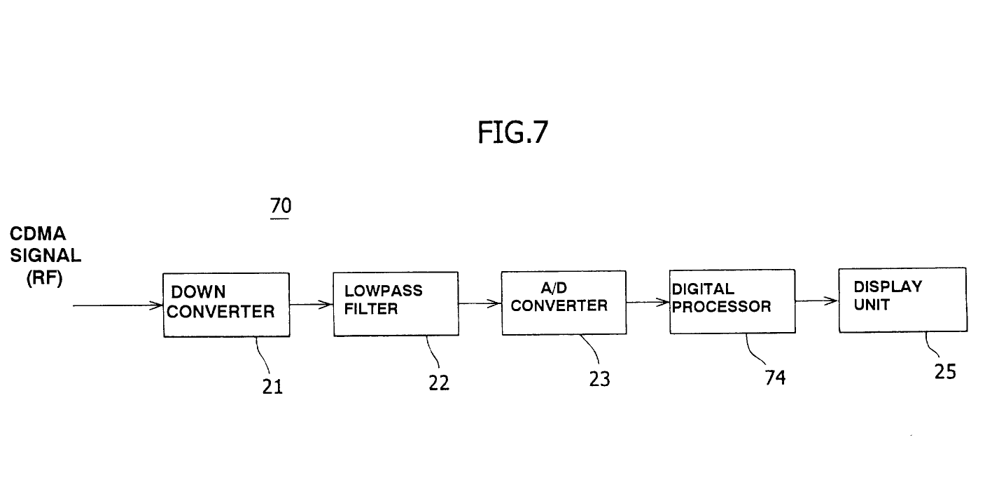

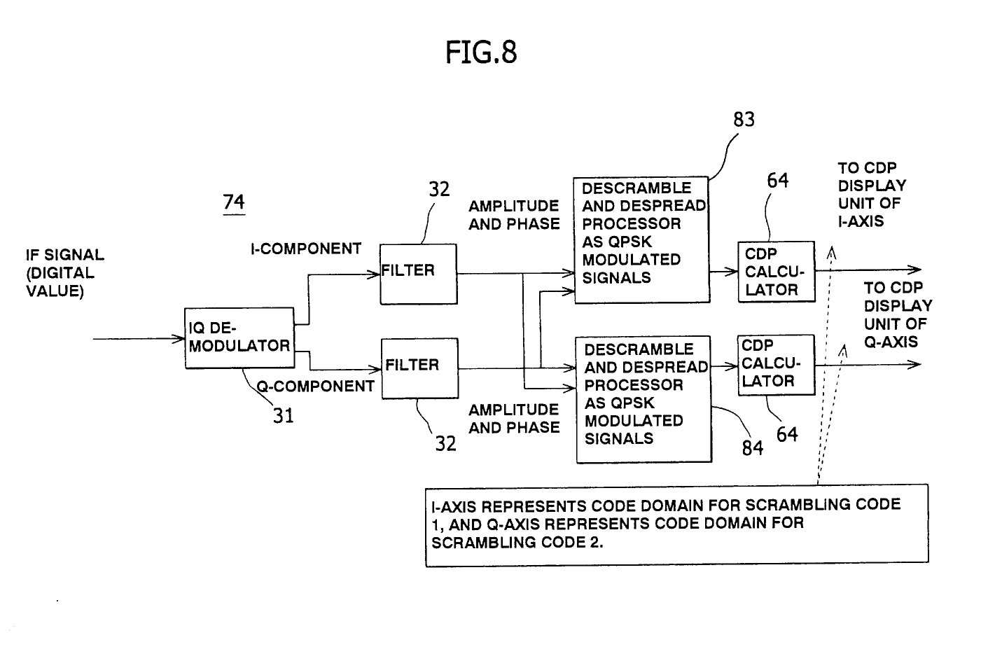

FIG. 7 shows a CDP analyzing apparatus 70 according to a second embodiment of the present invention, for displaying the power of code domains of different scrambling codes for a downstream signal. FIG. 8 is a detailed block diagram of a digital processor 74 which is part of the code domain power analyzing apparatus 70. The CDP analyzing apparatus 70 is capable of simultaneously displaying two types of signals of different scrambling codes (signals scrambled respectively by a first scrambling code and a second scrambling code) respectively above and below a code axis. The signals thus displayed make it possible to easily observe leakages of code domain power across sectors or cells. The arrangement shown in FIGS. 7 and 8 has been devised to carry out such a displaying process. The CDP displaying apparatus according to the second embodiment is the same as the CDP displaying apparatus according to the first embodiment except for the digital signal processor 74. The second embodiment is also characterized by the digital signal processor 74. In the digital signal processor 74, a digital IF signal generated by the A/D converter 23 is IQ-demodulated into two signals containing amplitude and phase information. The two signals as QPSK modulated signals are descrambled and despread (by a first descrambler/despreading means 83) with a first scrambling code, and are simultaneously descrambled and despread (by a second descrambler/despreading means 84) with a second scrambling code. The two signals thus descrambled and despread with the respective two scrambling codes are processed to calculate CDP by the respective CDP calculators 64 for displaying the CDP above and below the code axis. The CDP calculators 64 generate signals for displaying the bars as shown in FIG. 4 on the display unit 25.

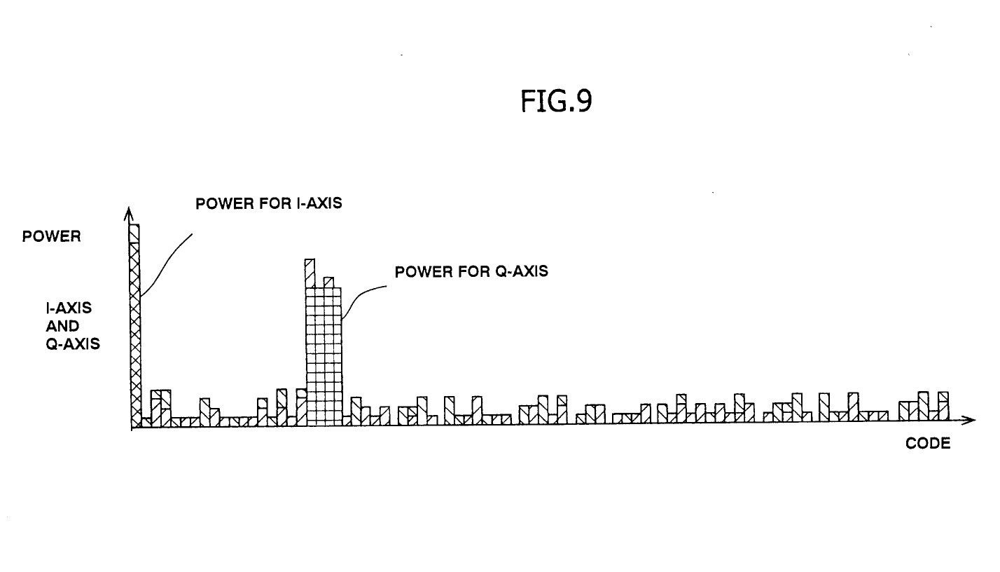

According to a third embodiment of the present invention, as shown in FIG. 9, the bars are of the same type as described above, but the power of the I-axis and the power of the Q-axis are displayed in a stacked fashion. This display mode is suitable for observing the total power for the same code that is distributed on the I-axis and the Q-axis. The display mode is also effective in confirming the power distribution for the codes because the power distribution is required in an initial phase of development of terminals. The display mode can be achieved by modifying the program in a stage for performing the CDP calculation by the digital signal processor 54 and 74.

The power distributed on the I-axis and the Q-axis may be expressed so as to be identified visually with some attributes (e.g., colors or patterns) of the bars that indicate the power, so that the power of a desired code and the power due to an error can be distinguished from each other. This method is particularly effective because it allows the power distributed on the axes can easily be identified, according to the third embodiment, and because it allows the total power for the same code that is distributed on the I-axis and the Q-axis to be easily observed. This process can also be achieved by modifying the program of the digital signal processor.

While the most preferred embodiments of the present invention have been described in detail, the above embodiments may be modified or corrected without departing from the spirit of the present invention. The scope of the present invention is limited only by the description in the scope of claims for patent.

What is claimed is:

1. An apparatus for displaying code domain power in a CDMA signal analysis, comprising:
a down-converter for receiving a CDMA signal and down-converting the CDMA signal into an intermediate frequency (IF) signal;
an analog-to-digital (A/D) converter for converting the generated IF signal into a digital IF signal;
a digital signal processor for IQ-demodulating the digital IF signal, descrambling and despreading I and Q components to calculate code domain power (CDP); and
a display for displaying the CDP in response to signals from the digital signal processor;
wherein said digital signal processor descrambles and despreads I and Q component signals having amplitude and phase information obtained by demodulating the digital IF signal, individually as BPSK modulated signals, calculates CDPs with respect to I- and Q-axes from two different signals obtained by descrambling and despreading the I and Q component signals, and enables said display to display the calculated CDPs of each of the I- and Q-axes distinguishably.

2. An apparatus for displaying code domain power in a CDMA signal analysis, comprising a down-converter for receiving a CDMA signal and down-converting the CDMA signal into an intermediate frequency (IF) signal;
a analog-to-digital (A/D) converter for converting the generated IF signal into a digital IF signal;
a digital signal processor for demodulating the digital IF signal into I and Q components, descrambling and despreading the I and Q components to calculate code domain power (CDP); and
a display for displaying the CDP in response to signals from the digital signal processing means;
wherein said digital signal processor descrambles and despreads I and Q component signals having amplitude and phase information obtained by demodulating the digital IF signal, as QPSK modulated signals with a first scrambling code; simultaneously descrambles and despreads the I and Q component signals as QPSK modulated signals with a second scrambling code; calculates each CDP with respect to I- and Q-axes from two different signals obtained by descrambling and despreading the I and Q component signals with the scrambling codes; and enables the display to display the CDPs corresponding to the first and second scrambling codes distinguishably.

3. An apparatus according to claim 1, wherein said digital signal processor enables said display to display the CDPs calculated from said two different signals on respective different axes of dimension.

4. An apparatus according to claim 1, wherein said digital signal processor enables said display to display the CDPs calculated from said two different signals on an identical axis of dimension in a stacked fashion.

5. An apparatus according to claim 1, wherein said digital signal processing means enables said display means to display the CDPS visually distinguishably with colors or patterns, said CDPs are calculated from said two different signals.

6. A method of displaying code domain power, comprising: converting a frequency of a CDMA signal to generate an intermediate frequency (IF) signal, converting the IF signal into a digital IF signal for IQ-demodulating the digital IF signal, descrambling and despreading I and Q component signals obtained by IQ-demodulating the digital IF signal, as respective BPSK modulated signals, calculating a code domain power of an I-axis and a code domain power of a Q-axis from signals obtained by descrambling and despreading the I and Q component signals, and displaying the calculated code domain powers.

7. A method of displaying code domain power, comprising: converting a frequency of a CDMA signal to generate an intermediate frequency (IF) signal for converting the IF signal into a digital IF signal, IQ-demodulating the digital IF signal, descrambling and despreading I and Q component signals obtained by IQ-demodulating the digital IF signal, as respective QPSK modulated signals with a first scrambling code and a second scrambling code, calculating a code domain power with said first scrambling code and a code domain power with said second scrambling code from signals obtained by descrambling, and despreading the I and Q component signals and displaying the calculated code domain powers.

8. A method according to claim 6, wherein the CDPs calculated in the calculating step are displayed respectively on different axes of dimension.

9. A method according to claim 6, wherein the CDPs calculated in the calculating step are displayed on an identical axis of dimension.

10. A method according to claim 6, wherein the CDPs calculated in the calculating step are displayed visually distinguishably with colors or patterns.
